(19) United States
(12) Patent Application Publication
(10) Pub. No.: US 2023/0161682 A1
(43) Pub. Date: May 25, 2023

(54) SEVERITY LEVEL-BASED METRICS FILTERING

(71) Applicant: VMWARE, INC., Palo Alto, CA (US)

(72) Inventors: Agila GOVINDARAJU, Bangalore (IN); Rutuja DHAMALE, Bangalore (IN)

(21) Appl. No.: 17/530,539

(22) Filed: Nov. 19, 2021

(51) Int. Cl. G06F 11/34; G06F 16/21

(52) U.S. Cl. CPC G06F 11/3495; G06F 16/21

(57) ABSTRACT

In one example, a computer implemented method may include receiving metrics of a monitored computing-instance from a monitoring agent running in the monitored computing-instance. The received metrics may include a first metric and a plurality of dependent metrics for the first metric. Further, a data structure representing a relationship between the first metric and a plurality of dependent metrics may be retrieved. The data structure may include multiple metric dependency levels with each metric dependency level mapped to a corresponding one of severity conditions. Furthermore, a severity level of the first metric may be determined based on the severity conditions in the data structure. Further, the received metrics may be filtered based on the data structure and the severity level of the first metric. Upon filtering, the filtered metrics may be ingested to a monitoring tool to monitor a health of the monitored computing-instance.

### TECHNICAL FIELD

The present disclosure relates to computing environments, and more particularly to methods, techniques, and systems for filtering metrics of monitored computing-instances based on severity levels.

### BACKGROUND

In application/operating system (OS) monitoring environments, a management node may communicate with multiple endpoints to monitor the endpoints. For example, an endpoint may be implemented in a physical computing environment, a virtual computing environment, or a cloud computing environment. Further, the endpoints may execute different applications via virtual machines (VMs), physical computing devices, containers, and the like. In such environments, the management node may communicate with the endpoints to collect performance data/metrics (e.g., application metrics, OS metrics, and the like) from underlying OS and/or services on the endpoints for storage and performance analysis (e.g., to detect and diagnose issues).

### BRIEF DESCRIPTION OF THE DRAWINGS

FIG. 1 is a block diagram of an example system, depicting a computing node to filter metrics of a monitored computing instance prior to ingesting to a monitoring tool;

FIG. 2A is a flow diagram, illustrating an example method to generate a metric dependency graph knowledge base, as shown in FIG. 1;

FIGS. 2B and 2C depict example definitions for a set of severity levels and associated conditions for a metric;

FIG. 2D depicts an example directed acyclic graph (DAG), depicting metric dependency levels for the metric;

FIG. 2E is an example data structure, depicting mapping of the set of severity levels of FIG. 2B and the metric dependency levels of the DAG of FIG. 2D;

FIG. 3 is a flow diagram, illustrating an example method for filtering metrics prior to ingesting the metrics to a monitoring tool;

FIG. 4 is a flow diagram, illustrating another example method for filtering metrics prior to ingesting the metrics to a monitoring tool; and

FIG. 5 is a block diagram of an example computing node including non-transitory computer-readable storage medium storing instructions to filter metrics prior to ingesting to a monitoring tool.

The drawings described herein are for illustration purposes and are not intended to limit the scope of the present subject matter in any way.

### DETAILED DESCRIPTION

Examples described herein may provide an enhanced computer-based and/or network-based method, technique, and system to filter metrics based on severity levels for ingesting into a monitoring tool in a computing environment. Computing environment may be a physical computing environment (e.g., an on-premise enterprise computing environment or a physical data center) and/or virtual computing environment (e.g., a cloud computing environment, a virtualized environment, and the like).

The virtual computing environment may be a pool or collection of cloud infrastructure resources designed for enterprise needs. The resources may be a processor (e.g., central processing unit (CPU)), memory (e.g., random-access memory (RAM)), storage (e.g., disk space), and networking (e.g., bandwidth). Further, the virtual computing environment may be a virtual representation of the physical data center, complete with servers, storage clusters, and networking components, all of which may reside in virtual space being hosted by one or more physical data centers. The virtual computing environment may include multiple physical computers executing different endpoints (e.g., physical computers, virtual machines, and/or containers). The endpoints may execute different types of applications.

Further, performance monitoring of such computing-instances (i.e., the endpoints) has become increasingly important because performance monitoring may aid in troubleshooting (e.g., to rectify abnormalities or shortcomings, if any) the computing-instances, provide better health of data centers, analyse the cost, capacity, and/or the like. An example performance monitoring tool or application or platform may be VMware® vRealize Operations (vROps), Vmware Wavefront™, Grafana, and the like.

Further, the computing-instances may include monitoring agents (e.g., Telegraf™, collectd, Micrometer, and the like) to collect the performance metrics from the respective computing-instances and provide, via a network, the collected performance metrics to a remote collector. Furthermore, the remote collector may receive the performance metrics from the monitoring agents and transmit the performance metrics to the monitoring tool for metric analysis. A remote collector may refer to an additional cluster node that allows the monitoring tool (e.g., vROps Manager) to gather objects into the remote collector's inventory for monitoring purposes. The remote collectors collect the data from the computing-instances and then forward the data to a management node that executes the monitoring tool. For example, remote collectors may be deployed at remote location sites while the monitoring tool may be deployed at a primary location.

Furthermore, the monitoring tool may receive the performance metrics, analyse the received performance metrics, and display the analysis in a form of dashboards, for instance. The displayed analysis may facilitate in visualizing the performance metrics and diagnose a root cause of issues, if any.

In such computing environments, the number of metrics collected by the application remote collector increases with an increase in the number of computing-instances. However, not all the collected metrics may be relevant for the metric analysis, for instance, when the computing-instance is performing well. Even though all the collected metrics may not be relevant, the metrics are ingested to the monitoring tool for performance analysis, which involves a significant amount of computation. Further, the monitoring tools may charge clients for every metric that is ingested to the monitoring tool. Since the metrics are not filtered based on relevance, clients may end up paying a significant amount for such monitoring tools.

Examples described herein may provide a computing node (e.g., a virtual machine that implements a remote collector service) to filter metrics of monitored computing-instances prior to ingesting to a monitoring tool. During operation, the computing node may receive the metrics of a monitored computing-instance from a monitoring agent running on the monitored computing-instance. Further, the computing node may retrieve a data structure corresponding to the received metrics. The data structure may be generated corresponding to historical events/incidents that occur in a datacenter. The data structure may include multiple metric dependency levels of the metrics with each metric dependency level mapped to a corresponding severity condition. Furthermore, the computing node may determine a severity level of a root metric of the received metrics using the retrieved data structure. Upon determining the severity level, the computing node may filter the received metrics based on the metric dependency levels in the data structure and the determined severity level. Further, the computing node may ingest the filtered metrics to the monitoring tool to monitor a health of the monitored computing-instance.

Thus, examples described herein may provide a knowledge base of historical incidents, which may be used to derive a mechanism to ingest relevant metrics to the monitoring tool. The computing node may receive the metrics from the monitoring agent and performs filtering of the metrics using the knowledge base of incidents prior to ingesting the metrics to the monitoring tool. Hence, examples described herein may bridge a gap between the monitoring agent and the monitoring tool by filtering the metrics dynamically, thereby reducing the cost for the clients.

In the following description, for purposes of explanation, numerous specific details are set forth in order to provide a thorough understanding of the present techniques. It will be apparent, however, to one skilled in the art that the present apparatus, devices, and systems may be practiced without these specific details. Reference in the specification to “an example” or similar language means that a particular feature, structure, or characteristic described is included in at least that one example, but not necessarily in other examples.

System Overview and Examples of Operation

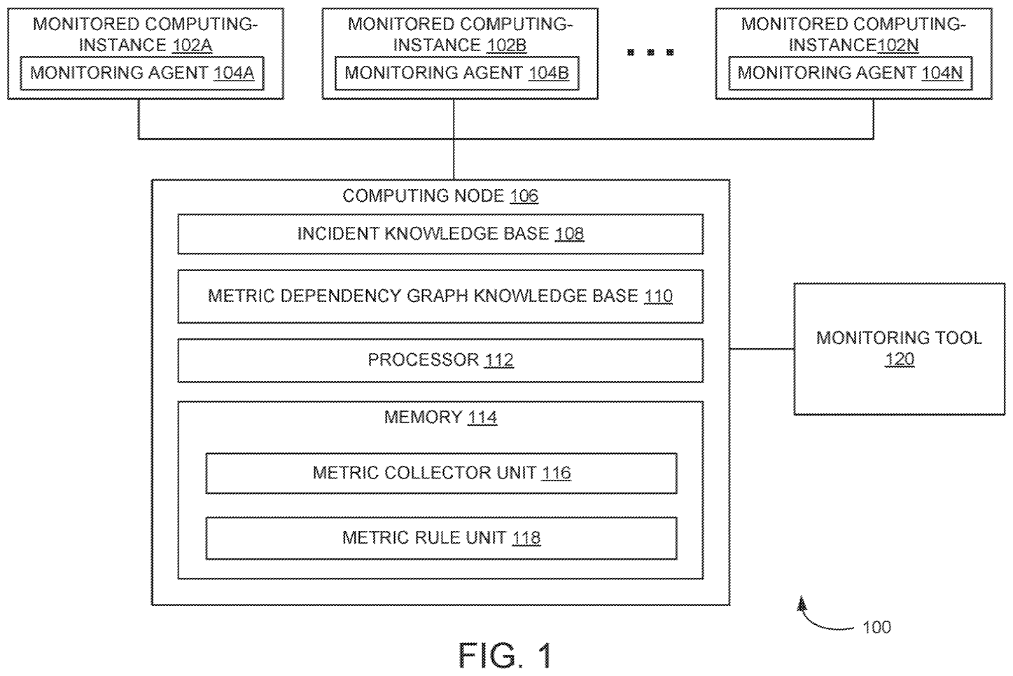

FIG. 1 is a block diagram of an example system 100, depicting a computing node 106 to filter metrics of a monitored computing instance (e.g., 102A) prior to ingesting to a monitoring tool 120. Example system 100 may include a computing environment such as a cloud computing environment (e.g., a virtualized cloud computing environment). For example, the cloud computing environment may be VMware vSphere®. The cloud computing environment may include one or more computing platforms that support the creation, deployment, and management of virtual machine-based cloud applications. An application, also referred to as an application program, may be a computer software package that performs a specific function directly for an end user or, in some cases, for another application. Examples of applications may include MySQL, Tomcat, Apache, word processors, database programs, web browsers, development tools, image editors, communication platforms, and the like.

Example system 100 includes monitored computing-instances 102A-102N, a monitoring tool 120, and a computing node 106 to receive the metrics (e.g., performance metrics) from monitored computing-instances 102A-102N and transmit the metrics to monitoring tool 120 for metric analysis. Example monitored computing-instances 102A-102N may include, but not limited to, virtual machines, physical host computing systems, containers, software defined data centers (SDDCs), and/or the like. For example, monitored computing-instances 102A-102N can be deployed either in an on-premises platform or an off-premises platform (e.g., a cloud managed SDDC). Further, the SDDC may include various components such as a host computing system, a virtual machine, a container, or any combinations thereof. Example host computing system may be a physical computer. The physical computer may be a hardware-based device (e.g., a personal computer, a laptop, or the like) including an operating system (OS). The virtual machine may operate with its own guest OS on the physical computer using resources of the physical computer virtualized by virtualization software (e.g., a hypervisor, a virtual machine monitor, and the like). The container may be a data computer node that runs on top of host operating system without the need for the hypervisor or separate operating system.

Further, monitored computing-instances 102A-102N includes corresponding monitoring agents 104A-104N to monitor respective computing-instances 102A-102N. In an example, monitoring agent 104A deployed in monitored computing-instance 102A fetches the metrics from various components of monitored computing-instance 102A. For example, monitoring agent 104A real-time monitors computing-instance 102A to collect metrics (e.g., telemetry data) associated with an application or an operating system running in monitored computing-instance 102A. Example monitoring agents 104A-104N include Telegraf agents, Collectd agents, or the like. Example metrics may include performance metric values associated with at least one of central processing unit (CPU), memory, storage, graphics, network traffic, or the like.

An example computing node 106 may be a remote collector, which is an additional cluster node that allows monitoring tool 120 to gather the metrics for monitoring purposes. For example, computing node 106 may be a physical computing device, a virtual machine, a container, or the like. Computing node 106 receives the metrics from monitoring agents 104A-104N via a network and filter the metrics prior to ingesting the metrics to monitoring tool 120. In an example, computing node 106 may be connected external to monitoring tool 120 via the network.

An example network can be a managed Internet protocol (IP) network administered by a service provider. For example, the network may be implemented using wireless protocols and technologies, such as WiFi, WiMax, and the like. In other examples, the network can also be a packet-switched network such as a local area network, wide area network, metropolitan area network, Internet network, or other similar type of network environment. In yet other examples, the network may be a fixed wireless network, a wireless local area network (LAN), a wireless wide area network (WAN), a personal area network (PAN), a virtual private network (VPN), intranet or other suitable network system and includes equipment for receiving and transmitting signals.

Further, computing node 106 includes an incident knowledge base 108. Incident knowledge base 108 stores historical events that occur in a datacenter. Further, incident knowledge base 108 stores metrics that are relevant for each historical event and dependency relationship between the metrics corresponding to each historical event.

Furthermore, computing node 106 includes a metric dependency graph knowledge base 110 to store a data structure representing the relationship between a plurality of metrics. In an example, the data structure includes multiple metric dependency levels of the metrics with each metric dependency level mapped to a corresponding severity condition. The data structure may be a directed acyclic graph (DAG) including the metric dependency levels indicating an order of dependency between the plurality of metrics. The directed acyclic graph may include a plurality of nodes each representing a metric of the plurality of metrics and a set of edges connecting the plurality of nodes representing dependency relationships between the plurality of metrics. Incident knowledge base 108 and metric dependency graph knowledge base 110 may be stored in a storage device of computing node 106 or in a storage device connected external to computing node 106.

Furthermore, computing node 106 includes a processor 112 and a memory 114. The term “processor” may refer to, for example, a central processing unit (CPU), a semiconductor-based microprocessor, a digital signal processor (DSP) such as a digital image processing unit, or other hardware devices or processing elements suitable to retrieve and execute instructions stored in a storage medium, or suitable combinations thereof. Processor 112 may, for example, include single or multiple cores on a chip, multiple cores across multiple chips, multiple cores across multiple devices, or suitable combinations thereof. Processor 112 may be functional to fetch, decode, and execute instructions as described herein.

During operation, for each historical event that occurs in a datacenter, processor 112 may:
generate a data structure corresponding to a historical event. The data structure may include multiple metric dependency levels of the metrics corresponding to the historical event.
define a set of severity conditions for a set of severity levels such that each severity condition is associated with one of the severity levels.
map each metric dependency level in the data structure to one of the severity levels.

Further, memory 114 includes a metric collector unit 116 and a metric rule unit 118. During operation, metric collector unit 116 receives metrics of a monitored computing-instance (e.g., 102A) from a monitoring agent (e.g., 104A) running on monitored computing-instance 102A. Further, metric collector unit 116 retrieves the data structure corresponding to the received metrics from metric dependency graph knowledge base 110.

Furthermore, metric rule unit 118 determines a severity level of a root metric (e.g., a parent metric) of the received metrics using the retrieved data structure. In an example, metric rule unit 118 determines that a value of the root metric matches a severity condition in the data structure. Further, metric rule unit 118 determines the severity level of the root metric corresponding to the matched severity condition.

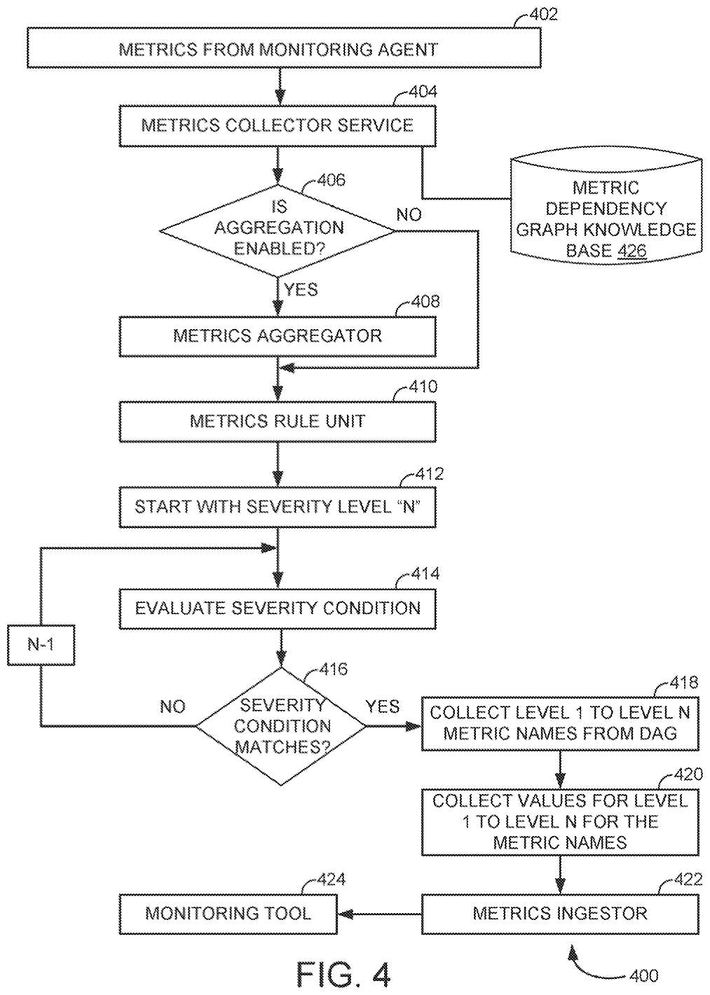

Further, metric rule unit 118 filters the received metrics based on the metric dependency levels in the data structure and the determined severity level. In an example, metric rule unit 118 determines a metric dependency level based on the severity level of the root metric. Further, metric rule unit 118 may filter the received metrics by discarding the metrics that correspond to metric dependency levels greater than the determined metric dependency level. An example process to filter the metrics is described in FIG. 4.

Furthermore, metric rule unit 118 ingests the filtered metrics to monitoring tool 120 to monitor health of monitored computing-instance 102A. In an example, metric rule unit 118 may
select the filtered metrics corresponding to metric dependency levels less than or equal to the determined metric dependency level from the data structure,
collect values of the filtered metrics corresponding to the metric dependency levels less than or equal to the determined metric dependency level, and
ingest the collected values to monitoring tool 120 to monitor the health of monitored computing-instance 102A.

In some examples, the functionalities described in FIG. 1, in relation to instructions to implement functions of metric collector unit 116, metric rule unit 118, and any additional instructions described herein in relation to the storage medium, may be implemented as engines or modules including any combination of hardware and programming to implement the functionalities of the modules or engines described herein. The functions of metric collector unit 116 and metric rule unit 118 may also be implemented by a respective processor. In examples described herein, the processor may include, for example, one processor or multiple processors included in a single device or distributed across multiple devices. In some examples, functionalities of computing node 106 and monitoring tool 120 can be a part of management software (e.g., vROps and Wavefront that are offered by VMware®).

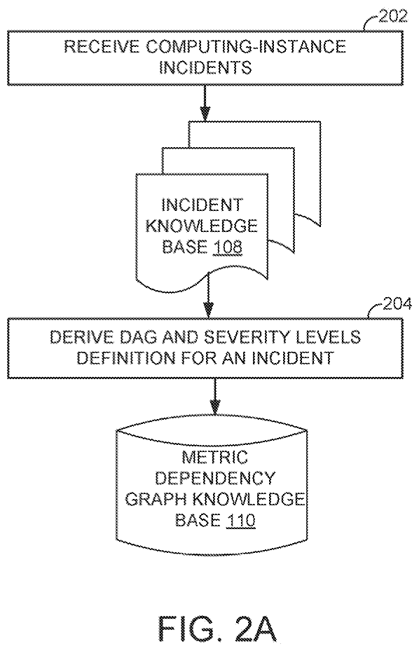

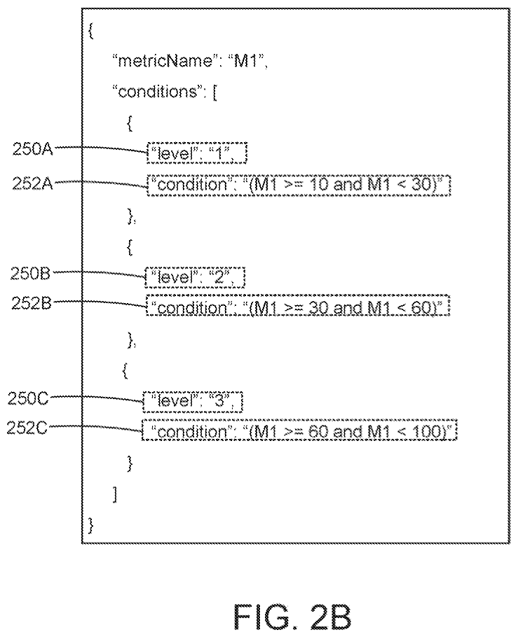

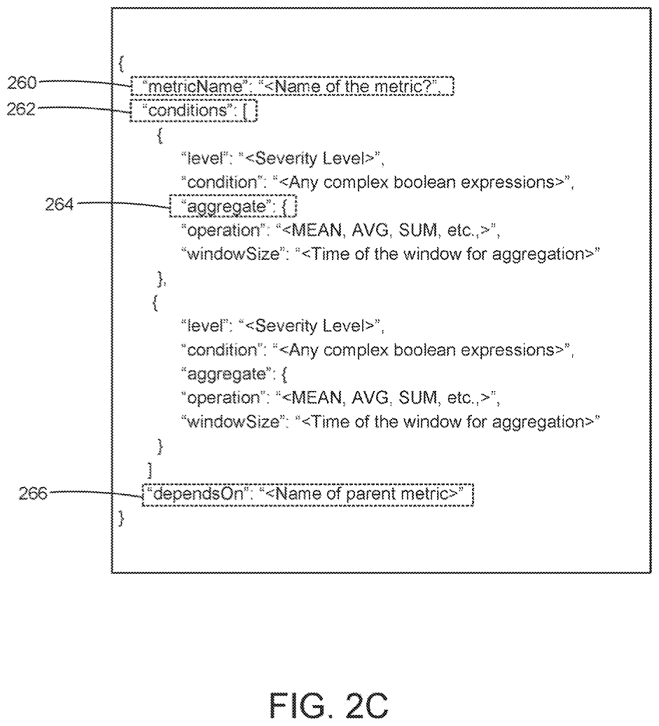

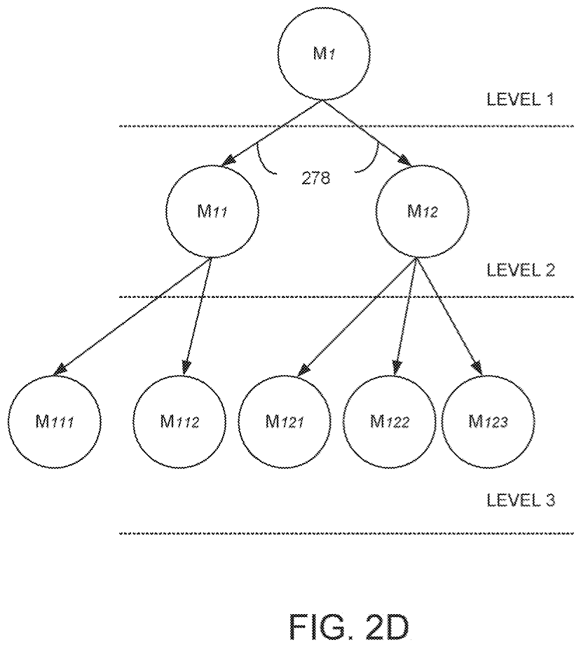

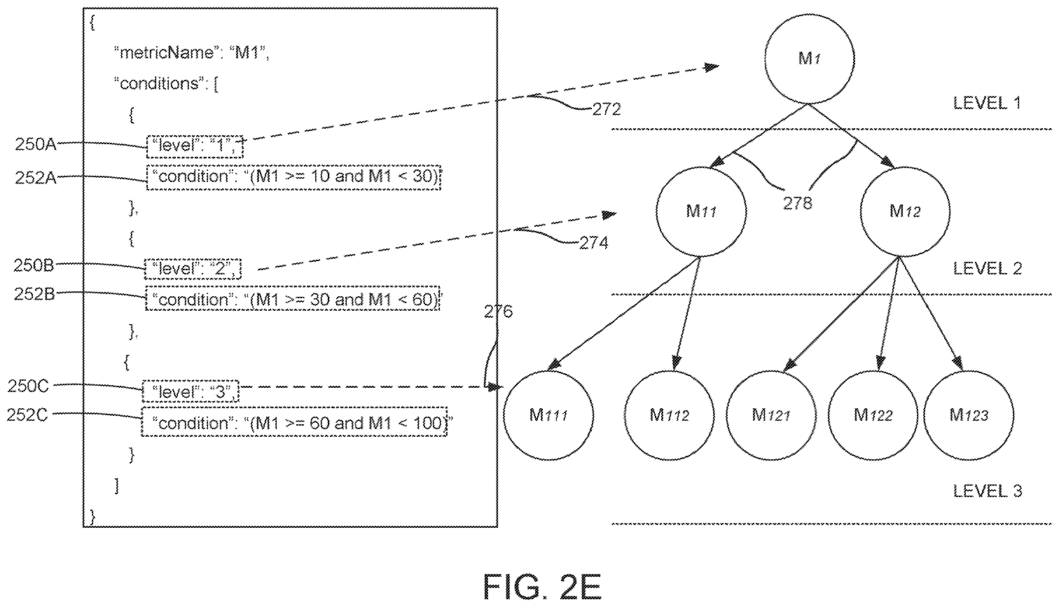

FIG. 2A is a flow diagram 200, illustrating an example method to generate metric dependency graph knowledge base 110, as shown in FIG. 1. It should be understood that the process depicted in FIG. 2A represents generalized illustrations, and that other processes may be added, or existing processes may be removed, modified, or rearranged without departing from the scope and spirit of the present application. In addition, it should be understood that the processes may represent instructions stored on a computer-readable storage medium that, when executed, may cause a processor to respond, to perform actions, to change states, and/or to make decisions. Alternatively, the processes may represent functions and/or actions performed by functionally equivalent circuits like analog circuits, digital signal processing circuits, application specific integrated circuits (ASICs), or other hardware components associated with the system. Furthermore, the flow charts are not intended to limit the implementation of the present application, but rather the flow charts illustrate functional information to design/fabricate circuits, generate machine-readable instructions, or use a combination of hardware and machine-readable instructions to perform the illustrated processes.

At 202, an incident occurred in a computing-instance (e.g., a datacenter) may be received. In a datacenter management, an incident tracker may report incidents or issues occurred in the datacenter. For example, an incident may be “slow workload/application performance on multiple virtual machines on multiple host computing systems”, “slow throughput for cold migrations”, and the like. Further, the incident may be translated to metrics related to the host computing systems, which in turn depends on metrics related to a network, a storage, and the like. Furthermore, the received incident and associated metrics may be stored in an incident knowledge base (e.g., incident knowledge base 108 as shown in FIG. 1). Thus, incident knowledge base 108 may receive incidents as a feedback loop to keep track of the incidents occurred in the datacenter. Further, incident knowledge base 108 may act as a knowledge base to analyze and arrive at set of metrics that are relevant for each incident.

At 204, a data structure (e.g., a directed acyclic graph (DAG)) and severity levels definition may be derived for each incident stored in incident knowledge base 108. For example, FIGS. 2B and 2C depict example definitions for a set of severity levels and associated conditions. Consider the set of severity levels as S₁ . . . Sₙ. S₁ representing severity level 1 (e.g., 250A of FIG. 2B), S₂ may represent severity level 2 (e.g., 250B of FIG. 2B), S₃ may represent severity level 3 (e.g., 250C of FIG. 2B), and so on. In an example, a severity condition against each severity level Si is defined as a metric (Mi) is in a range of Numₐ and Num_{b}, which is represented as:

severity level(Si)=Mi(Numₐ,Num_{b}).

In the example shown in FIG. 2B, severity condition 252A for a first severity level 250A is defined as a metric (M1) is in a range of 10 to 30, severity condition 252B for a second severity level 250B is defined as a metric (M1) is in a range of 30 to 60, and severity condition 252C for a third severity level 250C is defined as a metric (M1) is in a range of 60 to 100.

In another example as shown in FIG. 2C, the severity conditions against each of the severity level Si is defined as a Boolean expression which can depend on N number of metrics with various severity conditions. An example Boolean expression may be represented as an equation:

severity level(Si)=Mᵢ(numₐ,num_{b}) AND (Mⱼ(num_{c},num_{d}) OR Mₖ(numₑ,num_{f}))

An example Boolean expressing with metrices M1, M2, and M3 may be defined as M₁(10, 30) AND (M₂(40, 50) OR M₃(35, 45)), which my translate to:

(M₁>=10 and M₁<=30) AND ((M₂>=40 and M₂<=50) OR (M₃>×=35 and M₃<=45)).

As shown in FIG. 2C, metric name 260 may define a name of the metric. Conditions 262 may define the severity levels along with respective conditions for evaluation. Further, when “aggregate” (e.g., 264) is defined, then aggregated metric may be ingested for that level accumulating for a given time window to determine the severity level. Furthermore, “dependsOn” (e.g., 266) may define whether the current metric has any relationship with any other metric. In an example, for a given metric, there could be N number of severity levels defined. For example, a metric M₁ can have three severity levels defined as S₁, S₂, and S₃. Further, each of these severity levels (Sᵢ) may be mapped to a Boolean expression evaluating the metric values of M₁ or any other relevant metrics, as depicted in FIG. 2C. Further, “metricName” (e.g., 260), “conditions” (e.g., 262), “aggregate” (e.g., 264), and “dependsOn” (e.g., 266) may facilitate in construction of the DAG.

FIG. 2D depicts an example DAG, depicting metric dependency levels for the metric. The DAG may include metric dependency levels indicating an order of dependency between the plurality of metrics. For example, DAG may include a plurality of nodes (e.g., M₁, M₁₁, M₁₂, M₁₁₁, M₁₁₂, M₁₂₁, and the like) each representing a metric of the plurality of metrics and a set of edges (e.g., 278) connecting the plurality of nodes representing dependency relationships between the plurality of metrics. In the example shown in FIG. 2D, metric M₁ is at a metric dependency level 1, metrics M₁₁ and M₁₂ are at a metric dependency level 2, and metrics M₁₁₁, M₁₁₂, M₁₂₁, M₁₂₂, M₁₂₃ are at metric dependency level 3.

In an example, metric dependency level 1 metrics (e.g., M1) may include “host health status”, metric dependency level 2 metrics (e.g., M₁₁ and M₁₂) may include “central processing unit (CPU) capacity usage”, “memory capacity usage”, “net throughput usage”, “disk throughput usage”, and the like. Further, metric dependency level 3 metrics (e.g., M₁₁₁, M₁₁₂, M₁₂₁, and so) may include “central processing unit load average time”, “memory capacity contention”, “net throughput provisioned”, “disk throughput contention”, and the like that depends on a corresponding one of the metric dependency level 2 metrics.

In an example, dependency of metrics can be arrived at with “dependsOn” (e.g., 266 of FIG. 2C) field. As shown in FIG. 2D, each incident may include a parent metric (e.g., M₁) at level 1. Further, the parent metric may include multiple child metrics (e.g., M₁₁ and M₁₂) at level 2. Furthermore, each child metric (e.g., M₁₁) may include multiple sub-child metrics (e.g., M₁₁₁ and M₁₁₂) at level 3.

Furthermore, the severity levels as depicted in FIG. 2B or 2C may be mapped to the metric dependency levels of the DAG of FIG. 2D. FIG. 2E is an example data structure, depicting mapping of the set of severity levels of FIG. 2B and the metric dependency levels of the DAG of FIG. 2D. Each metric dependency level in the DAG may be mapped to a severity level to arrive at the metrics that may have to be ingested to a monitoring tool or dropped. As shown in FIG. 2E, each severity condition (e.g., 252A, 252B, and 252C) may be mapped to different metric dependency levels 1, 2, and 3 (e.g., as shown by arrows 272, 274, and 276, respectively).

Referring back to FIG. 2A, metric dependency graph knowledge base 110 may be updated with the DAG of metrics associated to the severity levels definition along with its condition (e.g., as shown in FIG. 2E). For example, metric dependency graph knowledge base 110 may be updated for any incidents that occurs in the datacenter fetched from incident knowledge base 108. Thus, metric dependency graph knowledge base 110 may maintain the DAG of the metrics based on its learning from the various incidents along with the conditions defining the various severity levels. Further, metric dependency graph knowledge base 110 may serve as an input to a metrics rule unit (e.g., metric rule unit 118 of FIG. 1) to evaluate incoming metrics and ingest/drop the metrics based on the values. Thus, examples described herein may optimize cost for monitoring the computing-instances by dropping the metrics that are not relevant.

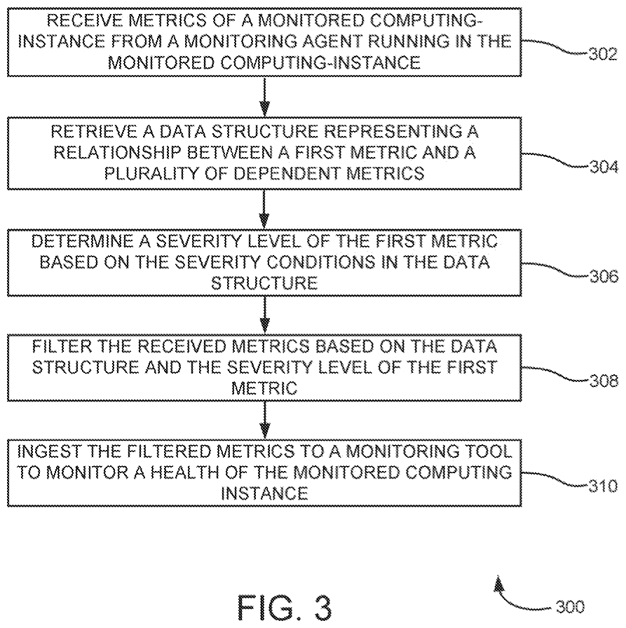

FIG. 3 is a flow diagram 300, illustrating an example method for filtering metrics prior to ingesting the metrics to a monitoring tool. At 302, metrics of a monitored computing-instance may be received from a monitoring agent running in the monitored computing-instance. In an example, the received metrics may include a first metric and a plurality of dependent metrics for the first metric. At 304, a data structure representing a relationship between the first metric and a plurality of dependent metrics may be retrieved. In an example, the data structure may include multiple metric dependency levels with each metric dependency level mapped to a corresponding one of severity conditions.

At 306, a severity level of the first metric may be determined based on the severity conditions in the data structure. In an example, determining the severity level of the first metric may include:
determining that a value of the first metric matches a severity condition in the data structure. In an example, the value of the first metric is an aggregated value of individual values over a period of time. For example, the aggregated value may be derived using an aggregation method. In another example, the value of the first metric may be an individual value at an instance of time.
determining the severity level of the first metric corresponding to the matched severity condition.

At 308, the received metrics may be filtered based on the data structure and the severity level of the first metric. In an example, filtering the received metrics may include:
determining a metric dependency level corresponding to the severity level of the first metric, and
filtering the received metrics by discarding the metrics that correspond to metric dependency levels greater than the determined metric dependency level.

At 310, the filtered metrics may be ingested to a monitoring tool to monitor a health of the monitored computing-instance. In an example, ingesting the filtered metrics to the monitoring tool may include ingesting values of the filtered metrics over a period to the monitoring tool to monitor the health of the monitored computing-instance. In another example, ingesting the filtered metrics to the monitoring tool may include:
aggregating values of the filtered metrics over a period, and
ingesting the aggregated values of the filtered metrics over the period to the monitoring tool to monitor the health of the monitored computing-instance.

FIG. 4 is a flow diagram 400, illustrating another example method for filtering metrics prior to ingesting the metrics to a monitoring tool. At 402, metrics associated with a monitored computing-instance may be received from a monitoring agent. At 404, a metrics collector service (e.g., computing node 106 of FIG. 1) may fetch a DAG for the received metrics along with corresponding severity definitions (e.g., as shown in FIG. 2E) from a metrics dependency graph knowledge base 426 (e.g., metric dependency graph knowledge base 110 of FIG. 1). The DAG may represent a parent metric and a plurality of child metrics.

At 406, the metrics collector service may check whether an “aggregate” option (e.g., as shown in field 264 of FIG. 2C) is enabled based on the DAG. When the “aggregate” option is enabled, a metrics aggregator may perform the aggregation operations on the metric, over a time window, that is sent as input to a metrics aggregator and returns the result, at 408. If the “aggregate” is not enabled, then the result may be the incoming metric value itself.

At 410, the resultant metric value along with the DAG and severity definition may be transmitted to a metrics rule unit (e.g., metric rule unit 118 of FIG. 1). In an example, the metrics rule unit may use the received information that is provided by the metrics collector service and performs the evaluation as shown in blocks 412 to 424.

At 412, a severity level “N” may be considered to evaluate the resultant metric value. At 414, the resultant metric value of the parent metric may be evaluated against a severity condition associated with the severity level “N” in a data structure. At 416, a check may be made to determine whether the severity condition matches with the resultant metric value. When the severity condition matches, at 418, metrics names of metric dependency level 1 to metric dependency level N may be collected from the DAG. At 420, metrics values for metric dependency level 1 to metric dependency level N for the metrics names may be collected. Further, the metric values from metric dependency level N+1 onwards may be dropped.

When the severity condition does not match, the severity level “N” may be reduced by “1” and the steps 414 to 424 may be repeated to evaluate the resultant metric value. When the severity condition “N−1” matches, metrics names of metric dependency level 1 to metric dependency level N−1 may be collected from the DAG and metrics values for metric dependency level 1 to metric dependency level N−1 for the metrics names may be collected. Further, the metric values from metric dependency level N onwards may be dropped. Thus, the process is repeated until the resultant metric value matches with one of the severity conditions in the data structure.

Considering DAG of FIG. 2E, when a resultant metric value evaluated to be at metric dependency level 2, then metric dependency level 2+metric dependency level 1 metrics may be ingested to the monitoring tool. Further, any metric from metric dependency level 2+1 onwards may be dropped. In this example, metric dependency level 3 metrics may be dropped. Thus,
Metrics Ingested=Level 1 to Level N
Metrics Dropped=Level N+1 onwards

At 422, the filtered metrics may be ingested to the monitoring tool by a metrics ingestor. At 424, the monitoring tool may analyze the filtered metrics to determine health of different components of computing-instance.

In an example, for ingesting a metric to the monitoring tool, it costs X, so to send N number of metrics to the monitoring tool, it may cost X*N. With the examples described herein, by mapping the various severity levels to the number of metrics that will be ingested, the cost may be reduced. For example, consider ingesting metrics at a frequency of 1 min and a monitoring agent is pushing 7 metrics to the collector service. When the metrics are not filtered, all the 7 metrics are ingested to the monitoring tool. So, cost would be X*7. With the examples described herein, 7 metrics may be grouped to various levels in a form of the DAG like:
Level 1->1 Metric
Level 2->2 Metrics
Level 3->5 Metrics

In an example, only 1 metric may be ingested when the computing-instance is working normal, which would have costed only X*1. Thus, 7× times reduction in the cost may be achieved, which is 86% of savings. In another example, when the working condition deteriorates, there will be a gradual increase in the cost. For example, the cost may reach its maximum and equates to X*7 when an incident occurs. Thus, examples described herein may facilitate to ingest the necessary metrics in the various phases of the incident occurrence namely pre-incident, incident, and post-incident to understand the issues better and analyze them from the monitoring tool while having a control on the number of metrics that gets ingested which is directly proportionate to cost.

It should be understood that the processes depicted in FIGS. 3 and 4 represent generalized illustrations, and other processes may be added, or existing processes may be removed, modified, or rearranged without departing from the scope and spirit of the present application. In addition, it should be understood that the processes may represent instructions stored on a computer-readable storage medium that, when executed, may cause a processor to respond, to perform actions, to change states, and/or to make decisions. Alternatively, the processes may represent functions and/or actions performed by functionally equivalent circuits like analog circuits, digital signal processing circuits, application specific integrated circuits (ASICs), or other hardware components associated with the system. Furthermore, the flow charts are not intended to limit the implementation of the present application, but rather the flow charts illustrate functional information to design/fabricate circuits, generate machine-readable instructions, or use a combination of hardware and machine-readable instructions to perform the illustrated processes.

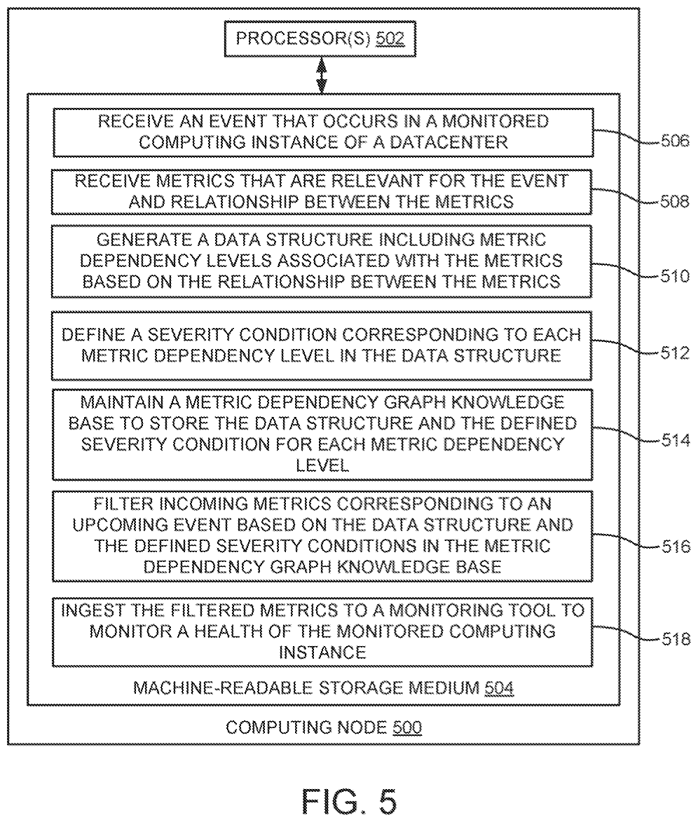

FIG. 5 is a block diagram of an example computing node 500 including non-transitory computer-readable storage medium 504 storing instructions to filter metrics prior to ingesting to a monitoring tool. Computing node 500 may include a processor 502 and machine-readable storage medium 504 communicatively coupled through a system bus. Processor 502 may be any type of central processing unit (CPU), microprocessor, or processing logic that interprets and executes machine-readable instructions stored in machine-readable storage medium 504. Machine-readable storage medium 504 may be a random-access memory (RAM) or another type of dynamic storage device that may store information and machine-readable instructions that may be executed by processor 502. For example, machine-readable storage medium 504 may be synchronous DRAM (SD RAM), double data rate (DDR), Rambus® DRAM (RDRAM), Rambus® RAM, etc., or storage memory media such as a floppy disk, a hard disk, a CD-ROM, a DVD, a pen drive, and the like. In an example, machine-readable storage medium 504 may be a non-transitory machine-readable medium. In an example, machine-readable storage medium 504 may be remote but accessible to computing node 500.

Machine-readable storage medium 504 may store instructions 506, 508, 510, 512, and 514. Instructions 506 may be executed by processor 502 to receive an event that occurs in a monitored computing-instance of a datacenter. Instructions 508 may be executed by processor 502 to receive metrics that are relevant for the event and relationship between the metrics.

Instructions 510 may be executed by processor 502 to generate a data structure including metric dependency levels associated with the metrics based on the relationship between the metrics. In an example, the data structure may be a directed acyclic graph (DAG) including the metric dependency levels indicating an order of dependency between the plurality of metrics.

Instructions 510 may be executed by processor 502 to define a severity condition corresponding to each metric dependency level in the data structure. In an example, instructions to define the severity condition comprise instructions to:
define a plurality of severity conditions for a plurality of severity levels such that each severity condition is associated with one of the severity levels; and
map each metric dependency level in the data structure to one of the severity levels.

Instructions 510 may be executed by processor 502 to maintain a metric dependency graph knowledge base to store the data structure and the defined severity condition for each metric dependency level;

Instructions 512 may be executed by processor 502 to filter incoming metrics corresponding to an upcoming event based on the data structure and the defined severity conditions in the metric dependency graph knowledge base. In an example, instructions to filter the incoming metrics corresponding to an upcoming event may include instructions to:
retrieve the data structure corresponding to the incoming metrics from the metric dependency graph knowledge base;
determine a severity level of a root metric of the incoming metrics using the severity conditions in the retrieved data structure;
determine a metric dependency level that is mapped to the determined severity level of the root metric; and
filter the incoming metrics by discarding the metrics that correspond to metric dependency levels greater than the determined metric dependency level.

Instructions 514 may be executed by processor 502 to ingest the filtered metrics to a monitoring tool to monitor a health of the monitored computing-instance.

Machine-readable storage medium 504 may further store instructions to be executed by processor 502 to receive a second event that occurs in a monitored computing-instance of a datacenter; and update the metric dependency graph knowledge base with a second data structure of metrics that are relevant to the second event along with associated severity conditions.

Some or all of the system components and/or data structures may also be stored as contents (e.g., as executable or other machine-readable software instructions or structured data) on a non-transitory computer-readable medium (e.g., as a hard disk; a computer memory; a computer network or cellular wireless network or other data transmission medium; or a portable media article to be read by an appropriate drive or via an appropriate connection, such as a DVD or flash memory device) so as to enable or configure the computer-readable medium and/or one or more host computing systems or devices to execute or otherwise use or provide the contents to perform at least some of the described techniques.

It may be noted that the above-described examples of the present solution are for the purpose of illustration only. Although the solution has been described in conjunction with a specific embodiment thereof, numerous modifications may be possible without materially departing from the teachings and advantages of the subject matter described herein. Other substitutions, modifications and changes may be made without departing from the spirit of the present solution. All of the features disclosed in this specification (including any accompanying claims, abstract and drawings), and/or all of the steps of any method or process so disclosed, may be combined in any combination, except combinations where at least some of such features and/or steps are mutually exclusive.

The terms “include,” “have,” and variations thereof, as used herein, have the same meaning as the term “comprise” or appropriate variation thereof. Furthermore, the term “based on”, as used herein, means “based at least in part on.” Thus, a feature that is described as based on some stimulus can be based on the stimulus or a combination of stimuli including the stimulus.

The present description has been shown and described with reference to the foregoing examples. It is understood, however, that other forms, details, and examples can be made without departing from the spirit and scope of the present subject matter that is defined in the following claims.

What is claimed is:

1. A computer implemented method comprising:
receiving metrics of a monitored computing-instance from a monitoring agent running in the monitored computing-instance, the received metrics comprising a first metric and a plurality of dependent metrics for the first metric;
retrieving a data structure representing a relationship between the first metric and a plurality of dependent metrics, the data structure comprising multiple metric dependency levels with each metric dependency level mapped to a corresponding one of severity conditions;
determining a severity level of the first metric based on the severity conditions in the data structure;
filtering the received metrics based on the data structure and the severity level of the first metric; and
ingesting the filtered metrics to a monitoring tool to monitor a health of the monitored computing-instance.

2. The computer implemented method of claim 1, wherein determining the severity level of the first metric comprises:
determining that a value of the first metric matches a severity condition in the data structure; and
determining the severity level of the first metric corresponding to the matched severity condition.

3. The computer implemented method of claim 2, wherein the value of the first metric is an aggregated value of individual values over a period of time, and wherein the aggregated value is derived using an aggregation method.

4. The computer implemented method of claim 2, wherein the value of the first metric is an individual value at an instance of time.

5. The computer implemented method of claim 1, wherein filtering the received metrics comprises:
determining a metric dependency level corresponding to the severity level of the first metric; and
filtering the received metrics by discarding the metrics that correspond to metric dependency levels greater than the determined metric dependency level.

6. The computer implemented method of claim 1, wherein ingesting the filtered metrics to the monitoring tool comprises:
ingesting values of the filtered metrics over a period to the monitoring tool to monitor the health of the monitored computing-instance.

7. The computer implemented method of claim 1, wherein ingesting the filtered metrics to the monitoring tool comprises:
aggregating values of the filtered metrics over a period; and
ingesting the aggregated values of the filtered metrics over the period to the monitoring tool to monitor the health of the monitored computing-instance.

8. A non-transitory machine-readable storage medium comprising instructions that, when executed by a processor of a computing node, cause the processor to:
receive an event that occurs in a monitored computing-instance of a datacenter;
receive metrics that are relevant for the event and relationship between the metrics;
generate a data structure including metric dependency levels associated with the metrics based on the relationship between the metrics;
define a severity condition corresponding to each metric dependency level in the data structure;
maintain a metric dependency graph knowledge base to store the data structure and the defined severity condition for each metric dependency level;
filter incoming metrics corresponding to an upcoming event based on the data structure and the defined severity conditions in the metric dependency graph knowledge base; and
ingest the filtered metrics to a monitoring tool to monitor a health of the monitored computing-instance.

9. The non-transitory machine-readable storage medium of claim 8, wherein instructions to define the severity condition comprise instructions to:
define a plurality of severity conditions for a plurality of severity levels such that each severity condition is associated with one of the severity levels; and
map each metric dependency level in the data structure to one of the severity levels.

10. The non-transitory machine-readable storage medium of claim 8, further comprising instructions to:
receive a second event that occurs in a monitored computing-instance of a datacenter; and
update the metric dependency graph knowledge base with a second data structure of metrics that are relevant to the second event along with associated severity conditions.

11. The non-transitory machine-readable storage medium of claim 8, wherein instructions to filter the incoming metrics corresponding to an upcoming event comprise instructions to:
retrieve the data structure corresponding to the incoming metrics from the metric dependency graph knowledge base;
determine a severity level of a root metric of the incoming metrics using the severity conditions in the retrieved data structure;
determine a metric dependency level that is mapped to the determined severity level of the root metric; and
filter the incoming metrics by discarding the metrics that correspond to metric dependency levels greater than the determined metric dependency level.

12. The non-transitory machine-readable storage medium of claim 8, wherein the data structure is a directed acyclic graph (DAG) comprising the metric dependency levels indicating an order of dependency between the plurality of metrics.

13. A computing node comprising:
a metric dependency graph knowledge base to store a data structure representing a relationship between a plurality of metrics, the data structure comprising multiple metric dependency levels of the metrics with each metric dependency level mapped to a corresponding severity condition;
a processor; and
a memory comprising:
a metric collector unit to:
receive metrics of a monitored computing-instance from a monitoring agent running on the monitored computing-instance; and
retrieve the data structure corresponding to the received metrics from the metric dependency graph knowledge base; and
a metric rule unit to:
determine a severity level of a root metric of the received metrics using the retrieved data structure;
filter the received metrics based on the metric dependency levels in the data structure and the determined severity level; and
ingest the filtered metrics to a monitoring tool to monitor a health of the monitored computing-instance.

14. The computing node of claim 13, wherein the data structure is a directed acyclic graph (DAG) comprising the metric dependency levels indicating an order of dependency between the plurality of metrics.

15. The computing node of claim 14, wherein the directed acyclic graph includes a plurality of nodes each representing a metric of the plurality of metrics and a set of edges connecting the plurality of nodes representing dependency relationships between the plurality of metrics.

16. The computing node of claim 13, further comprising:
an incident knowledge base to:
store historical events that occurs in a datacenter; and
store metrics that are relevant for each historical event and dependency relationship between the metrics corresponding to each historical event.

17. The computing node of claim 16, wherein the processor is to:
for each historical event,
generate a data structure corresponding to a historical event, wherein the data structure comprises multiple metric dependency levels of the metrics corresponding to the historical event;
define a set of severity conditions for a set of severity levels such that each severity condition is associated with one of the severity levels; and
map each metric dependency level in the data structure to one of the severity levels.

18. The computing node of claim 13, wherein the metric rule unit is to:
determine that a value of the root metric matches a severity condition in the data structure; and
determine the severity level of the root metric corresponding to the matched severity condition.

19. The computing node of claim 13, wherein the metric rule unit is to:
determine a metric dependency level based on the severity level of the root metric; and
filter the received metrics by discarding the metrics that correspond to metric dependency levels greater than the determined metric dependency level.

20. The computing node of claim 19, wherein the metric rule unit is to:
select the filtered metrics corresponding to metric dependency levels less than or equal to the determined metric dependency level from the data structure;
collect values of the filtered metrics corresponding to the metric dependency levels less than or equal to the determined metric dependency level; and
ingest the collected values to a monitoring tool to monitor a health of the monitored computing-instance.
